(19) United States
(12) Patent Application Publication
(10) Pub. No.: US 2022/0012754 A1
(43) Pub. Date: Jan. 13, 2022

(54) SYSTEM OF EVALUATING REAL-TIME EMPLOYMENT RISK AND METHOD OF OPERATING

(71) Applicant: Zeta Global Corp., New York, NY (US)

(72) Inventors: David Steinberg, Miami Beach, FL (US); Neej Gore, San Francisco, CA (US); David Schey, New York, NY (US); Bashir Eghbali, San Francisco, CA (US)

(21) Appl. No.: 16/924,151

(22) Filed: Jul. 8, 2020

(51) Int. Cl. G06Q 30/02; G06Q 10/10; G06N 20/00; G06F 9/54; G06F 16/903

(52) U.S. Cl. CPC G06Q 30/0201; G06Q 10/105; G06Q 30/0277; G06K 7/10297; G06N 20/00; G06F 9/54; G06F 16/90344; G06Q 30/0244

(57) ABSTRACT

The system and method of the present invention provides customers with real-time information in order to evaluate future consumer spending capacity. The present invention can help to identify situations beyond traditional credit metrics to determine change of circumstances for end-consumers. The system allows for selection of consumers based on data trends and learned industry risk and behavior indicators.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND OF THE INVENTION

Merchants typically use consumer credit information—such as length of credit history, credit payment history, credit utilization, late payment history, in order to determine whether to offer credit to individuals. Typical consumer credit information can be slow to predict change of circumstances. There is a need for a real-time system.

Individual borrowers pay their loans or loan installments when they have the ability to pay. The ability to pay largely depends on a person's disposable income. And if a person's disposable income disappears due to the loss of his job, or due to income reduction resulting from a pay cut or a change in job or due to underemployment, then the person assumes a much higher risk of defaulting on his loan repayments simply because the person has no money and therefore has no ability to pay. That is why it is critical to predict a person's ability to pay based on his future probability of loss of income or a reduction in income in order to make a superior prediction of his creditworthiness. Today, the standard approach to credit scoring is through traditional credit scores but the problem is that they are increasingly becoming inaccurate, simply because they don't predict future ability to pay. They are essentially reactive scores, meaning they change after borrowers default, and do not factor changes in the economy, and purely rely on credit histories and consumers' past ability to pay.

Some existing models use further information, such as historical employment from loan applications, but they are slow to react and still rely on historic rather than predictive behaviors.

The problem this invention solves is that traditional scores are reactive and do not account for anticipated changes in individuals and industries. This invention uses real-time data to predict an individual's likely employment and update industry volatility based on that real time data.

### DESCRIPTION OF THE DRAWINGS

FIG. 1 is a block diagram of network environment

FIG. 2. is a block diagram of a computing device

FIG. 3 is a block diagram illustrating a representative software architecture which may be used in conjunction with various hardware architectures herein described.

FIG. 4 is a block diagram illustrating components of a machine, according to some example embodiments, able to read instructions from a machine-readable medium (e.g. a machine-readable storage medium) and perform any one or more of the methodologies discussed herein.

FIG. 5 is a block diagram of a real-time employment score system

FIG. 6 is a flow chart for method of tracking consumer behavior data

FIG. 7 is a flow chart for upgrading industry volatility

FIG. 8 is a flow chart for updating consumer employment score

FIG. 9 is a flow chart for selecting consumer lists

### DETAILED DESCRIPTION OF THE INVENTION

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention.

Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments. Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

As used herein, a database may be a relational database, flat file database, relational database management system, object database management system, operational database, data warehouse, hyper media database, post-relational database, hybrid database models, RDF database, key value database, XML database, XML store, text file, flat file or other type of database.

Although not required, the systems and methods are described in the general context of computer program instructions executed by one or more computing devices that can take the form of a traditional server/desktop/laptop; mobile device such as a smartphone or tablet; etc. Computing devices typically include one or more processors coupled to data storage for computer program modules and data. Key technologies include, but are not limited to, the multi-industry standards of Microsoft and Linux/Unix based Operation Systems; databases such as SQL Server, Oracle, NOSQL, and DB2; Business analytic/Intelligence tools such as SPSS, Cognos, SAS, etc.; development tools such as Java, NET framework (VB.NET, ASP.NET, AJAX.NET, etc.); and other e-Commerce products, computer languages, and development tools. Such program modules generally include computer program instructions such as routines, programs, objects, components, etc., for execution by the one or more processors to perform particular tasks, utilize data, data structures, and/or implement particular abstract data types. While the systems, methods, and apparatus are described in the foregoing context, acts and operations described hereinafter may also be implemented in hardware.

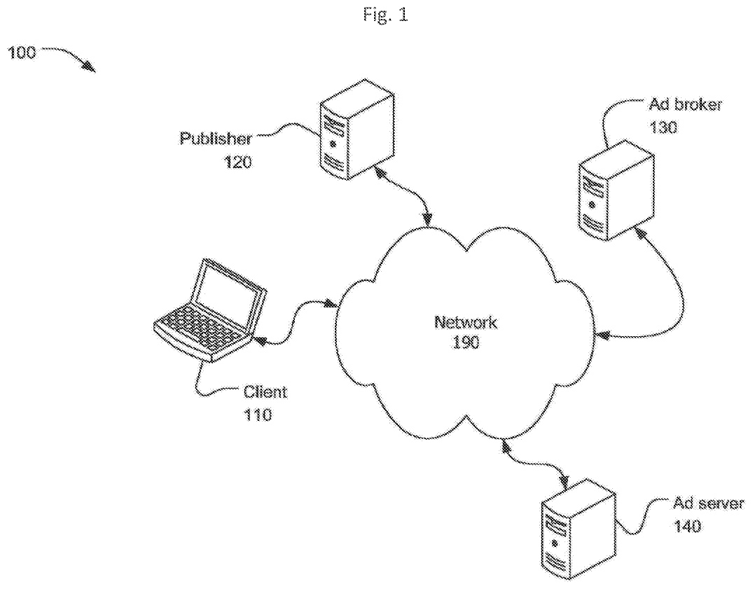

Aspects of the one or more particular embodiments described herein may be implemented on one or more computers or computing devices executing software instructions. The computers may be networked in a client-server arrangement or similar distributed computer network. FIG. 1 illustrates a computer network system 100 that implements one or more particular embodiments of a landing page optimization process. In system 100, network server computers 104 and 106 are coupled, directly or indirectly to one or more network client computers 102 through a network 110. The network interface between the server computers and client computers may include one or more routers (not shown) that serve to buffer and route the data transmitted between the computers. Network 110 may be the Internet, a Wide Area Network (WAN), a Local Area Network (LAN), or any combination thereof. The client computer can be any class of computing device, such as personal computer, workstation, laptop/notebook computer, personal computing device (PDA), or mobile communication or computing device, such as smartphone 118. The client computers could be coupled to network 110 directly or through intermediate networks, such as cell network 111.

In one example embodiment, a visitor using client computer 102 accesses one or more server computers, such as target server computer 106, which is a World-Wide Web (WWW) server that stores data in the form of web pages and transmits these pages as Hypertext Markup Language (HTML) files over the Internet 110 to the client computer 102, using a web server process 116. For this embodiment, the client computer 102 typically runs a web browser program 114 to access the web pages served by server computer 106 and any other available content provider or supplemental server, such as server 108. In a typical web browsing session, target server 106 can be a search engine server (e.g., Google), publisher or portal site (e.g., Yahoo, MSN), vendor site (e.g., Amazon, Ebay), company site or any other target web site. The target website served by server 106 typically contains its own content as well as hyper links to other sites or content directly served into the target web page from separate server computers. One such separate server computer is web page server 108. In one example embodiment, web page server computer 108 represents a landing page or ad server computer that serves advertisement messages or supplemental messages (collectively referred to as “ads” or “advertisements”) to the client computer 102 through the target website served by server 106. Server computer 108 can also serve landing pages that may be accessed through links or actions taken on the target server 106 by the visitor, such as in the case of a search engine query or hyperlink selection on the target website. The landing page server 108 may have access to a variety of different landing pages or ads that can be served to the visitor based on various different factors. Such content may be stored in a data store 121 closely coupled to server 108 or in a remote data store or other server resource. Data for such landing pages or ad messages could comprise any type of digital data, such as text, audio, graphic or video data. For this case, the server computer 108 executes a componentized web page process 118 that can build a web page that includes several objects or components. The components are selected or assembled in a manner that provides the most desirable or effective web page that is ultimately displayed to the visitor through client computer 102.

For the example embodiment illustrated in FIG. 1, the web page or ad served by server 108 is optimized based on defined criteria and processes executed by an optimizer server 104. Optimizer server 104 in network system 100 is a server computer that executes an optimizer process 112. Client versions of this process or client modules for this server process may also be executed on the client computer 102. This optimizer process 112 may represent one or more executable programs modules that are stored within network server 104 and executed locally within the server. Alternatively, however, it may be stored on a remote storage or processing device coupled to server 104 or network 110 and accessed by server 104 to be locally executed. In another example embodiment, the optimizer process 112 may be implemented in a plurality of different program modules, each of which may be executed by two or more distributed server computers coupled to each other, or to network 110 separately.

As shown in FIG. 1, the optimizer process 112 executed by server 104 includes a number of separate programming modules (or components) that serve to evaluate factors related to the visitor's access of the web page served by page server 108, analyze the web pages or ads that can possibly be served to the visitor, and then optimize the landing pages served to the visitor based on these, and other factors. In one example embodiment, the optimizer process 112 includes a visitor context analyzer component 122 that analyzes the various factors (contexts) dictating how the visitor has accessed or been directed to the landing page through the target website, and a testing module 124 that analyzes the different landing pages available, compares their effectiveness against one another and causes the most effective page or pages to be served by server 108. The testing component 124 selects the most efficient web page based on the visitor context results returned by the visitor context analyzer component 122. The optimizer process 112 may also provide authoring or modification tools to define landing page content. This function may work in conjunction with any componentized web page process 118 executed on the web server 108.

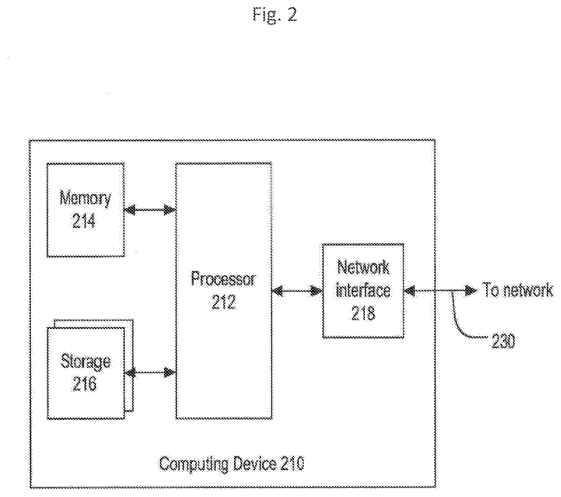

FIG. 2 depicts a computing device 210 used in conjunction with various embodiments described in this disclosure. The computing device 210 is ideally comprising a processor 212 connected to a memory 214, a storage 216, and a network interface 218 which connects to an external network 230.

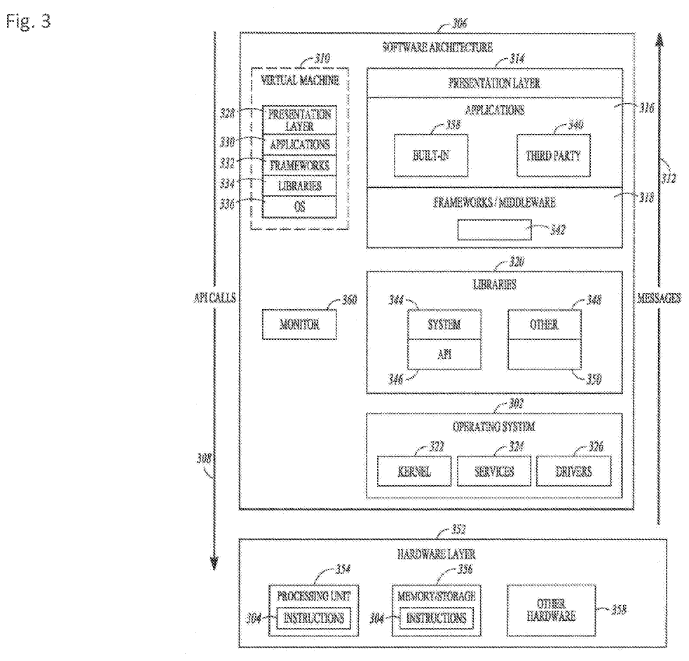

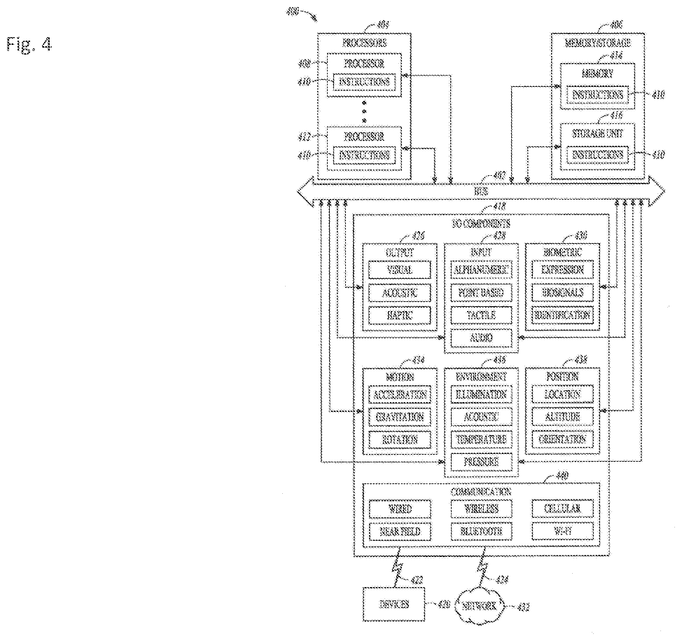

FIG. 3 is a block diagram illustrating an example software architecture 306, which may be used in conjunction with various hardware architectures herein described. FIG. 3 is a non-limiting example of a software architecture 306 and it will be appreciated that many other architectures may be implemented to facilitate the functionality described herein. The software architecture 306 may execute on hardware such as a machine 400 of FIG. 4 that includes, among other things, processors 404, memory/storage 406, and I/O components 418. A representative hardware layer 352 is illustrated and can represent, for example, the machine 400 of FIG. 4. The representative hardware layer 352 includes a processing unit 354 having associated executable instructions 304. The executable instructions 304 represent the executable instructions of the software architecture 306, including implementation of the methods, components, and so forth described herein. The hardware layer 352 also includes memory and/or storage modules as memory/storage 356, which also have the executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, frameworks/middleware 318, applications 316, and a presentation layer 314. Operationally, the applications 316 and/or other components within the layers may invoke application programming interface (API) API calls 308 through the software stack and receive messages 312 in response to the API calls 308. The layers illustrated are representative in nature, and not all software architectures have all layers. For example, some mobile or special-purpose operating systems may not provide a frameworks/middleware 318, while others may provide such a layer. Other software architectures may include additional or different layers.

The operating system 302 may manage hardware resources and provide common services. The operating system 302 may include, for example, a kernel 322, services 324, and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than by interfacing directly with the underlying operating system 302 functionality (e.g., kernel 322, services 324, and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media formats such as MPEG4, H264, MP3, AAC, AMR, IPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 (also sometimes referred to as middleware) provide a higher-level common infrastructure that may be used by the applications 316 and/or other software components/modules. For example, the frameworks/middleware 318 may provide various graphic user interface ((QUI) functions, high-level resource management, high-level location services, and so forth. The frameworks/middleware 318 may provide a broad spectrum of other APIs that may be utilized by the applications 316 and/or other software components/modules, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, and/or a game application. The third-party applications 340 may include any application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 340 may invoke the API calls 308 provided by the mobile operating system (such as the operating system 302) to facilitate functionality described herein.

The applications 316 may use built-in operating system functions (e.g., kernel 322, services 324, and/or drivers 326), libraries 320, and frameworks/middleware 318 to create user interfaces to interact with users of the system. Alternatively, or additionally, in some systems, interactions with a user may occur through a presentation layer, such as the presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (operating system 302 in FIG. 3) and typically, although not always, has a virtual machine monitor 360, which manages the operation of the virtual machine 310 as well as the interface with the host operating system (i.e., operating system 302). A software architecture executes within the virtual machine 310, such as an operating system (OS) 336, libraries 334, frameworks 332, applications 330, and/or a presentation layer 328. These layers of software architecture executing within the virtual machine 310 can be the same as corresponding layers previously described or may be different.

FIG. 4 is a block diagram illustrating components of a machine 400, according to some example embodiments, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, non-programmed machine into a particular machine programmed to carry out the specific described and illustrated functions in the manner described.

In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while only a single machine 400 is illustrated, the term “machine” shall also be taken to include a collection of machines that individually or jointly execute the instructions 410 to perform any one or more of the methodologies discussed herein.

The machine 400 may include processors 404, memory/storage 406, and I/O components 418, which may be configured to communicate with each other such as via a bus 402. The memory/storage 406 may include a memory 414, such as a main memory, or other memory storage, and a storage unit 416, both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor's cache memory), or any suitable combination thereof, during execution thereof by the machine 400. Accordingly, the memory 414, the storage unit 416, and the memory of the processors 404 are examples of machine-readable media.

The I/O components 418 may include a wide variety of components to receive input, provide output, produce output, transmit information, exchange information, capture measurements, and so on. The specific I/O components 418 that are included in a particular machine will depend on the type of machine. For example, portable machines such as mobile phones will likely include a touch input device or other such input mechanisms, while a headless server machine will likely not include such a touch input device. It will be appreciated that the I/O components 418 may include many other components that are not shown in FIG. 4. The I/O) components 418 are grouped according to functionality merely for simplifying the following discussion and the grouping is in no way limiting. In various example embodiments, the I/O components 418 may include output components 426 and input components 428. The output components 426 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 418 may include biometric components 430, motion components 434, environment components 436, or position components 438 among a wide array of other components. For example, the biometric components 430 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 434 may include acceleration sensor components (e.g., accelerometer), gravitation sensor components, rotation sensor components (e.g., gyroscope), and so forth. The environment components 436 may include, for example, illumination sensor components (e.g., photometer), temperature sensor components (e.g., one or more thermometers that detect ambient temperature humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 418 may include communication components 440 operable to couple the machine 400 to a network 432 or devices 420 via a coupling 424 and a coupling 422 respectively. For example, the communication components 440 may include a network interface component or another suitable device to interface with the network 432. In further examples, the communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a USB).

Moreover, the communication components 440 may detect identifier; or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geolocation, location via Wi-Fi® signal triangulation, location via detecting an NFC beacon signal that may indicate a particular location, and so forth.

In this example, the systems and methods are described in the general context of computer program instructions executed by one or more computing devices that can take the form of a traditional server/desktop/laptop; mobile device such as a smartphone or tablet; etc. Computing devices typically include one or more processors coupled to data storage for computer program modules and data. Key technologies include, but are not limited to, the multi-industry standards of Microsoft and Linux/Unix based Operating Systems; databases such as SQL Server, Oracle, NOSQL, and DB2; Business Analytic/Intelligence tools such as SPSS, Cognos, SAS, etc.; development tools such as Java, .NET Framework (VB.NET, ASP.NET, AJAX.NET, etc.); and other e-commerce products, computer languages, and development tools. Such program modules generally include computer program instructions such as routines, programs, objects, components, etc., for execution by the one or more processors to perform particular tasks, utilize data, data structures, and/or implement particular abstract data types. While the systems, methods, and apparatus are described in the foregoing context, acts and operations described hereinafter may also be implemented in hardware.

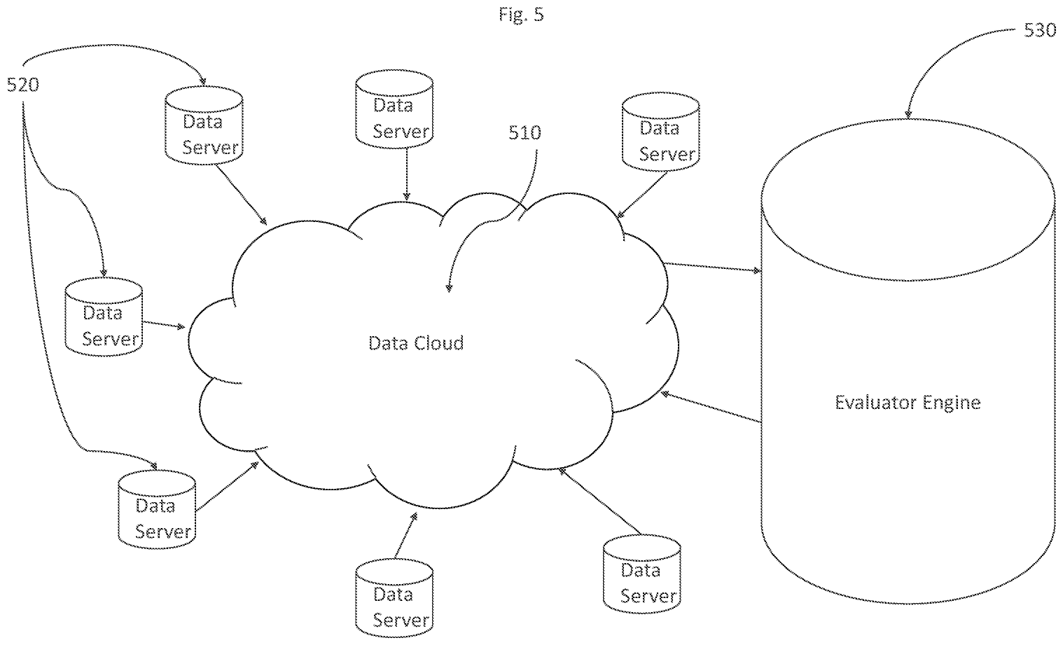

FIG. 5 depicts the invention in accordance with some embodiments of the present invention. The system is comprised of a data cloud 510 receiving data input from a number of data servers 520 and interacting with an evaluator server 530. Each of the data servers 520 sends data to the data cloud 510. FIG. 5 depicts five data servers 520, but it should be appreciated that there may be any number of data servers as is ideal for the system. Further, a single or multiple data sources may be housed in a single data server.

Once the data cloud 510 receives the data from the various data sources, it ingests it into relational databases matching to consumer ids.

An embodiment of an industry vertical data server system is depicted in FIG. 5. In some embodiments, one or more of the data servers 520 supplies industry vertical data. The data cloud 520 inputs industry data into the consumer relational databases to assign consumers with industry verticals for each consumer's employment sector. The data cloud 510 in conjunction with the evaluator engine 530, categorizes industry verticals and sectors into codes and assigns risk level to the industry verticals.

It should be appreciated that in ideal embodiments, the system dynamically adjusts the industry verticals and risk level for each industry vertical. This can be done by updated data from the industry vertical data server, by the evaluator learning trends in consumers maintaining employment within the verticals, by detecting collective behavior changes in consumers within the verticals, or some other machine learning means leveraging the data.

In some embodiments, the industry vertical data server provides updated known employment information for the consumers.

Consumer Browsing Data Server

In ideal embodiments, the system receives consumer browsing data from one or more browsing servers.

Fast retrieval store may be a key-value memory-based datastore that utilizes a network communication protocol. Fast retrieval store may comprises the end result of the other workers and stores used in connection with the system. It is the final data that is replicated out to all of the FEUH cluster nodes to help in the delivery of ads. Such data would take the form, in an exemplary embodiment, as follows: COMPANYID_NETWORK_MAPPING=[“SEGMENT1”, “SEGMENT2” ]. Thus, the key is a concatenation of (a) the unique user id, (b) the network company identifier, and (c) the contextual mapping identifier. SEGMENT1, SEGMENT 2 etc. are the names of the segments whose definitions match the user's behavior pattern. For example, 1235_cm_default=[“cm.sports_L”, “cm.polit_H” ] signifies user 12345 for the default context mapping on network; and cm matches the cm network sports-light and politics-heavy segments. This data organization supports any number of external data providers.

The following describes the steps that are involved in one embodiment of the behavioral targeting process. A user interface is provided that allows a company to setup behavioral segments by creating a classification mapping and setting behavioral parameters around that classification mapping. These parameters include the probability percentage that a page is about a certain classification, the frequency with which that type of classification is visited, and the recency or time interval involved, as described above.

Once the parameters are established, behavioral characterization is used in connection with the process of classification of Internet pages. As advertisements are served to a user viewing Internet pages and classification of the pages visited is accomplished, a cookie is dropped to uniquely identify the user.

A corresponding record to the cookie is created in the storage mechanism (i.e., data cloud) and the classification for that page is registered in the behavioral tallying cache. A process regularly reviews the behavioral tallying cache using the parameters setup by the company to identify users that qualify for various behavioral segments.

The data cloud is then updated with the behavioral segments and cache expirations are set as to maintain the validity of the behavioral segments. This is done to separate out users that are “in market” for various behaviors versus “out of market”. For example, consider a user that is looking for a new mortgage. In general, people typically do not look for a mortgage for over 30 days. The cached expiration helps contain the problem of infinite growth for those people who clear their cookies.

It should be appreciated that consumer browsing data can be matched with a consumer data base by any known method including pixel matching, device matching, known login matching, common browsing behavior matching, and the like.

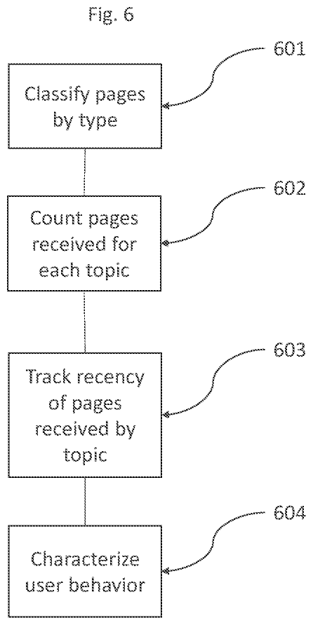

With reference to FIG. 6, a flow diagram of an exemplary method of the present invention is illustrated. In step 610, a plurality of pages viewed by a communications network user are classified as pertaining to one of a plurality of topics. In step 620 a count of each of the pages viewed by the communications network user for each of the topics is tracked, as is a recency with which each of the pages viewed by the communications network user was viewed for each of the topics, in step 630. The communications network user is characterized as belonging to one or more behavioral segments based on the number and the recency in step 640.

Location Data Server

In ideal embodiments, one or more data servers sends location data to the data cloud. Consumer browsing behavior contains geographical information. The geographic information is matched with consumer clusters in any known matching algorithm. Further, the geographic information is also matched with known or deduced locations based on the geographic data.

With this information, the evaluator can view consumers' physical location and can detect patterns. By way of example, if the consumer is viewing content from within a consistent office space, the geographic data may indicate that a consumer is browsing while at work. The geographic data may indicate a consumer is browsing from a residential address. This might indicate that the consumer is not leaving her home. Location data might alternatively show a consumer on the move during certain hours.

Transactional Data Server

In ideal embodiments, one or more data servers sends consumer transactional data to the data cloud. Consumer transactional data includes information on consumer transactions including what was purchased, from what location, what entity, and any consumer identifiable information. Once ingested by the data cloud, the data cloud uses algorithms to match the transactions to the individual consumer clusters.

Payment History Data Server

In ideal embodiments, one or more data servers sends consumer transactional data to the data cloud. Consumer payment history data includes traditional credit-worthiness data such as payments on credit, timeliness of payment, defaults, late payments. Once ingested by the data cloud, the data cloud uses algorithms to match the payment data to the individual consumer clusters.

Evaluator Server

The evaluator engine 530 works in conjunction with the data cloud 510 in evaluating collective consumer data. The evaluator engine 530 generates models around the various industry verticals.

To wit, the evaluator creates models of collective consumer behavioral data on industry and sector basis. Data from multiple data servers 820 are passed into a data cloud 810 and matched with individual consumer relational databases. The employment vertical volatility engine 860 takes an initial input of known industry vertical volatility 861 wherein the employment vertical volatility engine 860 contains collective industry/vertical

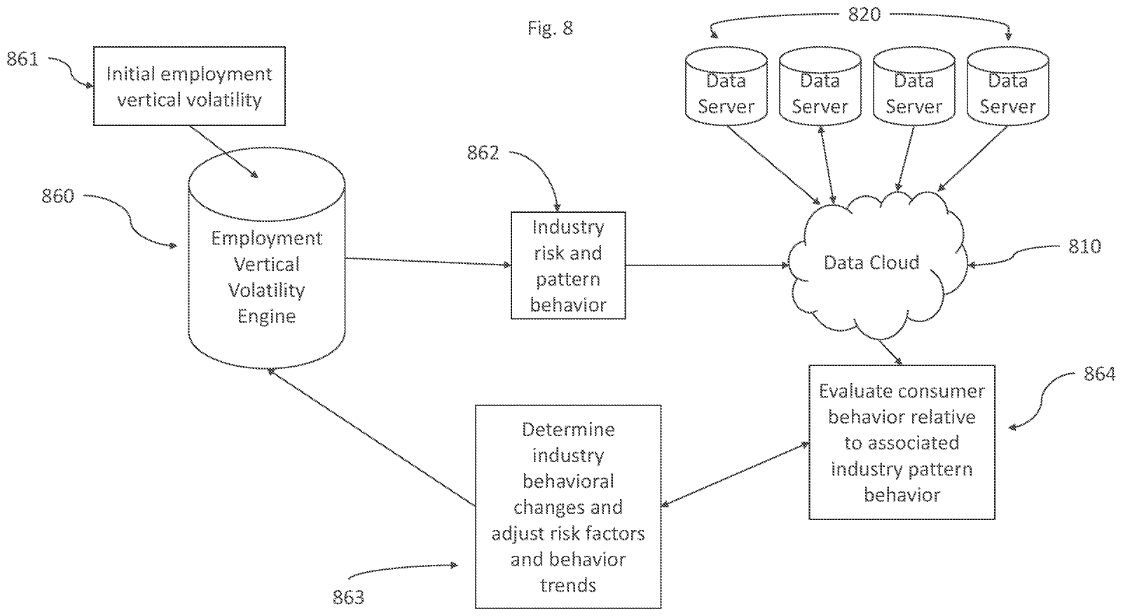

FIG. 8 depicts tuning the industry vertical volatility in accordance with some embodiments of the present invention.

The evaluator server processes the collective consumer data to generate behavior models around the various industry verticals. In doing so, the evaluator creates patterns of activity typical to consumers in the industry along with the degree of user conformity to the typical patterns. Such patterns may include purchasing behavior that may include a positive benchmarks (e.g. buying work apparel, travel thermos, etc.) and purchasing behavior that may indicate negative benchmarks with employment in the vertical (e.g. buying office supplies, increased travel purchases); location data that may indicate a positive benchmarks (e.g. consumers who are in the financial industry being in an office building, consumers who are in delivery industries having moving location data, and the like) and location data that may indicate a negative benchmarks (e.g. restaurant verticals having location data in a residential location, visiting cash advance locations), browsing behaviors may indicate positive benchmarks (e.g. looking to make a big purchase) or negative benchmarks (e.g. visiting job sites, researching budgets), the like.

Individual consumers' behavioral data is assessed as to the degree of behavior consistency with collective industry vertical. The degree of conformity between an individual consumer and the associated collective industry vertical. The evaluator uses the degree of conformity on positive and negative benchmarks in order to determine a degree of conformity with the employment risk of the industry. The evaluator then determines an employment risk score for the individual consumer based on the individual conformity and the industry risk score. In some embodiments, the evaluator transmits the individual employment risk score to the data cloud.

In some ideal embodiments, there are multiple employment risk scores in each individual consumer's relational database. In these embodiments, each transactional record is assigned an updated employment risk score. Each individual consumer would show employment risk trajectories based on the individual consumer's real time behavior.

In some embodiments, the data cloud further evaluates trending industry behavior and trending employment statistics. Thus the evaluator can measure in real time employment trends to track what industries have become more volatile for employment, which industries are hiring, and what behavior within those industries is considered positive or negative benchmarks.

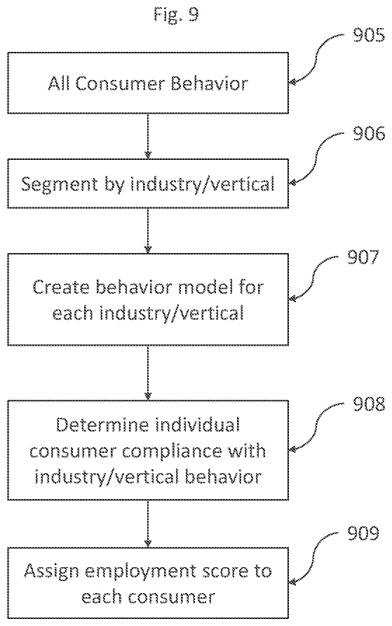

FIG. 9 depicts a flow chart for assigning an employment score to unique consumer profiles. Consumer behavior 905 is segmented by industry/vertical 906. The system evaluates the segmented behavioral data and creates models for each industry/vertical 907. The system evaluates unique consumer compliance with the industry/vertical model 908. Each consumer is then assigned an employment volatility score.

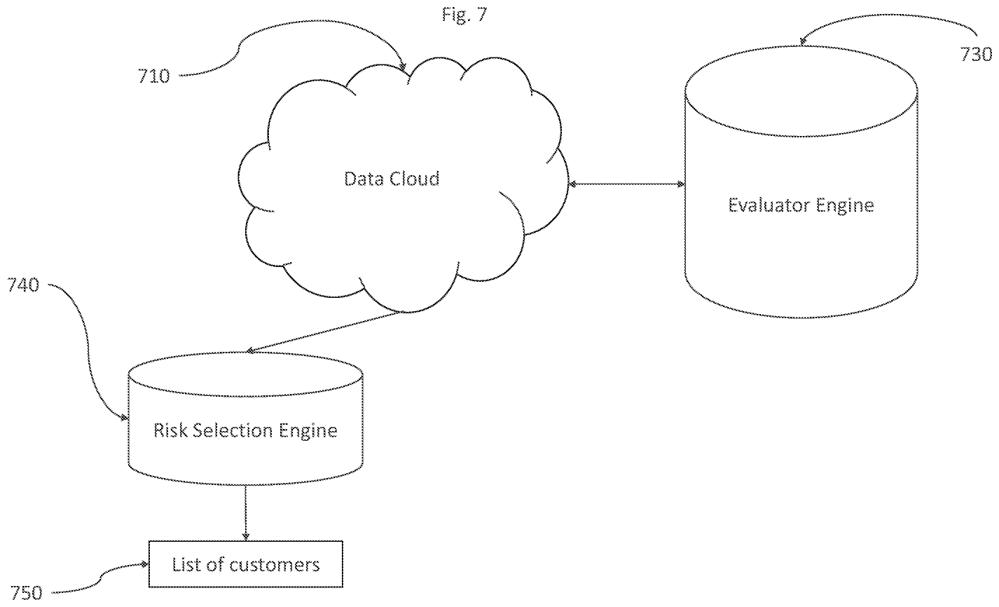

Risk Selection Server is further depicted in FIG. 7. In some embodiments, there is ideally a risk selection server 740 that selects individual consumers from the data cloud who meet certain risk thresholds. In these embodiments, the risk selection server segments users from the data cloud 710 based on whether certain conditions have been met.

In ideal embodiments, the risk selection server selects consumers that have a threshold increased or decreased in specific need for certain opportunities.

In certain ideal embodiments, the system is designed to measure employment risk. As such, the risk selection server may select users based on a downward employment risk score trajectory or once the consumer meets a specified threshold score. The risk selection server may predict consumers who have lost their employment before it would show up on a credit report or be recognized by a series of missed payments. The risk selection server may be used to present employment opportunities to these individuals, an increased risk for offering credit opportunities, or a reason to not target for discretionary spending. The risk selection server may also identify individuals who have low risk of job loss but who have decreased spending behavior as individuals to target for larger ticket items (e.g. vehicle, real estate, vacations) or certain products (e.g. financial planning).

It should be appreciated that the risk selection server may be running constantly and in real time to output individual consumers when they meet certain benchmark/thresholds or serve as a query as needed or on a scheduled basis.

The risk selection server may also be used to determine the risk level of making certain offers to the individual consumer. It should be appreciated that these offers may be of varying credit types including for refinance, mortgage, cash advance, personal loans, and the like.

It will be apparent to those skilled in the art that various modifications and variations can be made in connection with the system and method of the present invention without departing form the spirit or scope of the invention. Thus, it is intended that the present invention cover the modifications and variations of this invention provided they come within the scope of the appended claims and their equivalents.

1. A dynamic employment volatility scoring machine, the machine comprising:
receiving an initial volatility data for a plurality of industries through an input of an employment vertical volatility engine and stored on a memory wherein the memory stores a plurality of behavioral data for each of the industries;
receiving consumer data from a plurality of data servers through a data cloud input on a data cloud wherein the data cloud comprises a plurality of unique consumer profiles;
matching the consumer data to the plurality of unique consumer profiles;
receiving industry behavioral data from the employment vertical volatility engine into data cloud;
evaluating consumer behavior relative to industry behavioral data;
determining behavior trends for at least one of the industries; and
updating the employment vertical volatility engine.

2. The dynamic employment volatility scoring machine of claim 1 wherein the plurality of data servers includes data on consumer browsing, purchase, transactional data, payment history, or occupational history.

3. The dynamic employment volatility scoring machine of claim 1 further comprising identifying unique consumer profiles having differing behavior from its associated industry behavior.

4. The dynamic employment volatility scoring machine of claim 3 further comprising assigning an employment volatility score to each unique consumer profile.

5. The dynamic employment volatility scoring machine of claim 4 wherein the machine receives new consumer data in real-time and updates the employment volatility score for the associated unique consumer profile.

6. The dynamic employment volatility scoring machine of claim 5 wherein the updating the employment volatility score for the associated unique consumer profile step comprises adding a time-stamped version of the unique consumer profile employment volatility score.
